(19) United States
(12) Patent Application Publication
(10) Pub. No.: US 2007/0208786 A1
(43) Pub. Date: Sep. 6, 2007

(54) Method and apparatus for updating software

(75) Inventor: Young-suk Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/634,173

(22) Filed: Dec. 6, 2006

(30) Foreign Application Priority Data
Mar. 3, 2006 (KR) 10-2006-0020387

(51) Int. Cl. G06F 17/30

(52) U.S. Cl. 707/203

(57) ABSTRACT

A method and apparatus are provided for updating software by patching a previous version file to a new version file without creating a new file during a patch operation. The method of creating a delta file for updating software comprises: creating a delta file, which comprises a COPY command and an ADD command that are based on a difference between a previous version file and a new version file, by moving a window according to a sliding window method and expanding a size of the window to include data of the previous version file which will be replaced and deleted according to the ADD command while creating the delta file.

### CROSS-REFERENCE TO RELATED PATENT APPLICATIONS

This application claims priority from Korean Patent Application No. 10-2006-0020387, filed on Mar. 3, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to updating software, and more particularly, to a method and apparatus for patching a file to a new version of the file without creating a new file during the patching of the file.

2. Description of the Related Art

In general, a delta file is generated to create a new version of a file from a previous version of the file according to a software patch algorithm. The delta file consists of commands for performing certain operations and data used in the performing of the operations. The commands include ADD commands and COPY commands.

Delta files can be created according to either a full window (FW) method or an in-place sliding window (IPSW) method. The software patch algorithm related to the present invention is relevant to the FW method and the IPSW method.

For example, it is assumed that a previous version of a file and a new version of the file are as follows:

The previous version of the file: A B C D E F G H

The new version of the file: 1 2 3 A B C

FIGS. 1 and 2 are diagrams for explaining the creating of a delta file according to the FW method and the IPSW method, respectively.

A window is used to create a delta file by a patch algorithm, and hatched data portions (identified by an address in a window address range, 0-7) of FIGS. 1 and 2 are within the window. The window is referenced to create the delta file, and data portions that are not included in the window are not referenced. The address range of the window starts at 0 and is referenced to create data by a COPY command.

If the FW method is used to create a new version file using a delta file, an original file may not be modified because every portion of the original file may be referenced by COPY commands as data to be copied. As a result, the patch operation requires additional memory to store both the original file and the new version file.

When the IPSW method is used, less memory is required than when the FW method is used because a new version file may be written directly over an original file (that is, by an in-place patch method). However, since portions that have been deleted from the original file cannot be reused, a large amount of data must be added using ADD commands, and the size of a delta file created using the IPSW method is larger than the size of a delta file created using the FW method.

### SUMMARY OF THE INVENTION

Exemplary embodiments of the present invention may overcome the above disadvantages and other disadvantages not described above. The exemplary embodiments of the present invention are not necessarily required to overcome any of the disadvantages described above, and the exemplary embodiments of the present invention may not overcome any of the problems described above. The appended claims should be consulted to ascertain the true scope of the invention.

The present invention provides a method and apparatus for updating software, which can reduce a size of a delta file by reusing portions of an original file that have been conventionally deleted in a sliding window method.

The present invention also provides a computer readable medium having recorded thereon a computer readable program for performing the method of updating software.

According to an aspect of the present invention, there is provided a method of creating a delta file, the method comprising: creating a delta file which is composed of a COPY command and an ADD command that are based on a difference between a previous version file and a new version file while moving a window according to a sliding window method; and expanding a size of the window to include data of the previous version file which will be replaced and deleted while creating the delta file according to the ADD command.

The creating of the delta file may comprise: creating a join file with a series of data by combining data of the previous version file and data of the new version file; comparing data included in the window and data of the new version file starting from a position indicated by an input pointer while moving a window pointer which indicates a window starting point and the input pointer in unison by applying a sliding window method to the join file; and creating a delta file according to the COPY command when it is determined that there is common data after comparing the data included in the window and the data of the new version file, or according to the ADD command when it is determined that there is no common data.

Expanding the size of the window may comprise: storing temporarily the data of the previous version file which will be replaced and deleted while creating the delta file according to the ADD command; and expanding the size of the window to include the temporarily stored data.

According to another aspect of the present invention, there is provided a method of performing a software patch by a method of directly overwriting an original file using a delta file, the method comprising: temporarily storing data of the original file which will be deleted according to an ADD command and writing the data to the original file when a command of the delta file is the ADD command; and performing a COPY command of the delta file using the temporarily stored data.

According to still another aspect of the present invention, there is provideda method of performing a software patch by a method of directly overwriting an original file using a delta file, the method comprising: positioning a pointer at a beginning portion of the original file; determining whether a command of the delta file is an ADD command or a COPY command; when it is determined that the command of the delta file is the ADD command, temporarily storing data at the position indicated by the pointer, writing data at the position indicated by the pointer according to the ADD command, and moving the pointer according to data length of the ADD command; and when it is determined that the command of the delta file is the COPY command, copying data corresponding to an address and length of the COPY command at the position indicated by the pointer, and moving the pointer according to data length of the COPY command.

According to yet another aspect of the present invention, there is provided a method of updating software, the method comprising: creating a delta file while expanding the size of a window to include data of a previous version file which will be replaced and deleted according to an ADD command while creating the delta file using a sliding window method; receiving the created delta file; and reading the received delta file, temporarily storing data of a previous version file which will be replaced and deleted according to the ADD command, writing data of the ADD command to the original file, and performing a software patch using the temporarily stored data when a command of the delta file is the ADD command.

According to another aspect of the present invention, there is provided a server computer comprising: a delta file creating module that creates a delta file based on a difference between a previous version file and a new version file, the delta file including an ADD command and a COPY command using a sliding window method, and expands a size of a window to include data of the previous version file that will be replaced and deleted while creating the delta file including the ADD command; and a storage unit that stores the delta file created by the delta file creating module.

According to another aspect of the present invention, there is provided a client computer comprising: a patch module that overwrites an original file according to a command included in a delta file, temporarily stores data of a previous version file that will be replaced and deleted according to an ADD command, writes data according to the ADD command to the previous version file, and performs a software patch using the temporarily stored data when a command of the delta file is the ADD command; and a storage unit that stores the delta file created by the patch module.

According to another aspect of the present invention, there is provided a computer readable medium having recorded thereon a computer readable program for performing the method of creating the delta file and the method of performing patching.

### BRIEF DESCRIPTION OF THE DRAWINGS

The above and other aspects of the present invention will become more apparent by describing in detail exemplary embodiments thereof with reference to the accompanying drawings, in that:

FIG. 1 is a diagram illustrating delta file creation using a related art FW method;

FIG. 2 is a diagram illustrating delta file creation using a related art IPSW method;

FIG. 3 is a block diagram of a system in which a software updating method is used according to an exemplary embodiment of the present invention;

FIG. 4 is a flow chart illustrating a method of updating software according to an exemplary embodiment of the present invention;

FIG. 5 is a flow chart illustrating in detail procedures of creating a delta file according to an exemplary embodiment of the present invention;

FIG. 6 is a flow chart illustrating in detail patching procedures according to an exemplary embodiment of the present invention;

FIGS. 7A-7D are diagrams illustrating delta file creating procedures according to an exemplary embodiment of the present invention; and

FIGS. 8A-8C are diagrams illustrating patch implementation procedures according to an exemplary embodiment of the present invention.

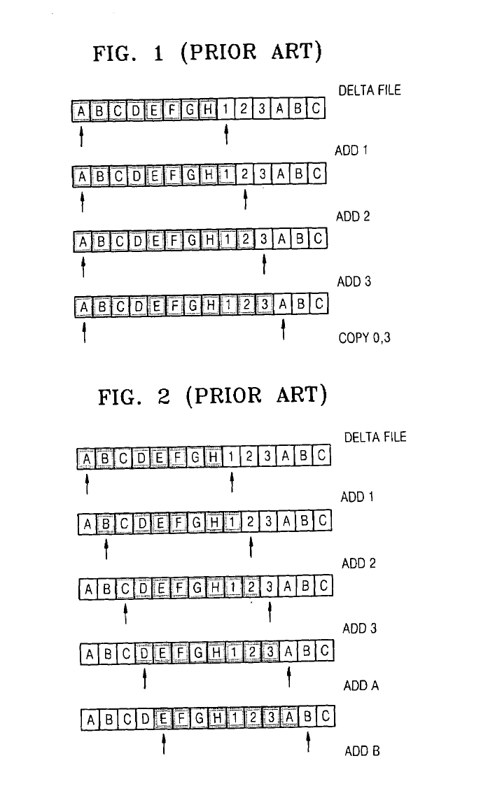

### DETAILED DESCRIPTION OF THE EXEMPLARY EMBODIMENTS

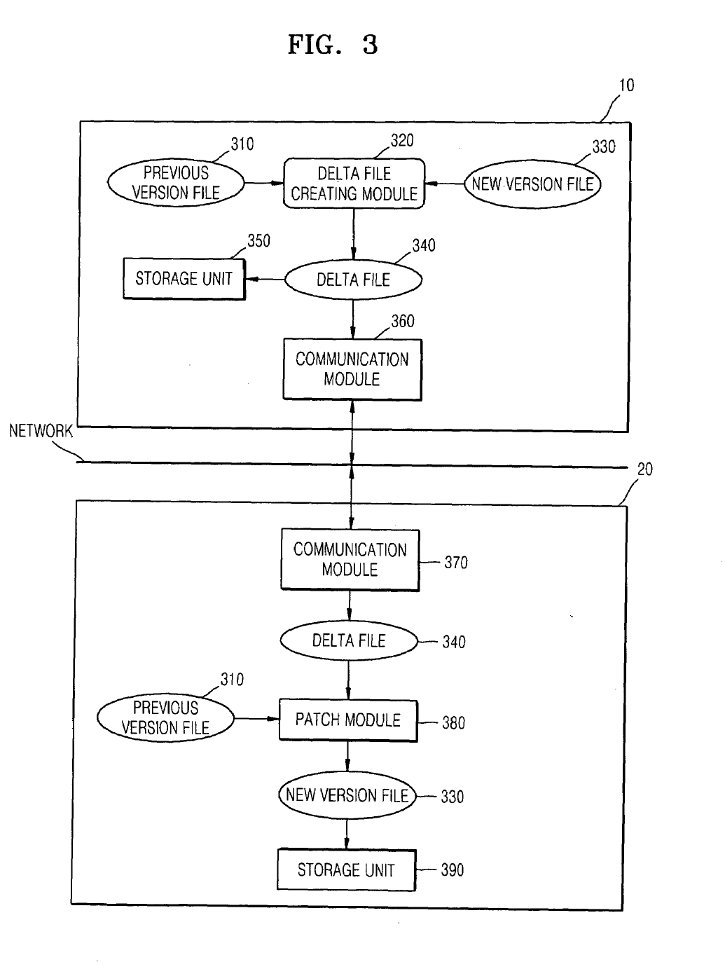

FIG. 3 is a block diagram of a system in which a software updating method is used according to an exemplary embodiment of the present invention. Referring to FIG. 3, the system includes a first computer 10 and a second computer 20, and the first and the second computers 10 and 20 are connected to each other via a network. Generally, the first computer 10 that creates a delta file is a server computer, and the second computer 20 that performs a patch using the delta file is a client computer.

The network may be, for example, a Universal Plug and Play (UPnP)-based network. However, the present invention is not limited to the UPnP-based network connection technology, and another network connection technology can be applied to the present invention.

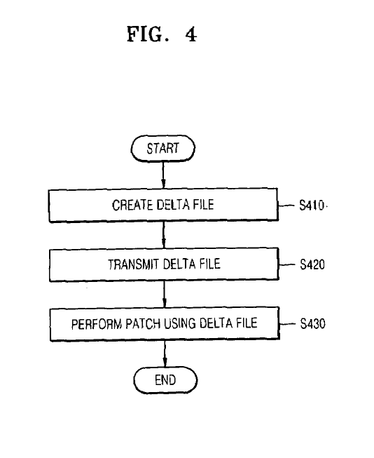

FIG. 4 is a flow chart illustrating procedures of updating software according to an exemplary embodiment of the present invention. Referring to FIG. 4, procedures for updating software include a delta file creation operation (S410), a delta file transmission operation (S420), and a patch implementation operation (S430) using the delta file.

The delta file creation operation (S410) is performed in the first computer 10 (server computer), the delta file transmission operation (S420) is performed through communication between the first computer 10 and the second computer 20 (client computer) on the network, and the patch implementation operation (S430) using the delta file is performed in the second computer 20.

Each operation for updating software will be described more specifically below.

A delta file creating module 320 included in the first computer 10 comprises hardware and software that compare a previous version file 310 (that is, an original file) with a new version file 330 and create a delta file based on a difference between the files 310 and 330.

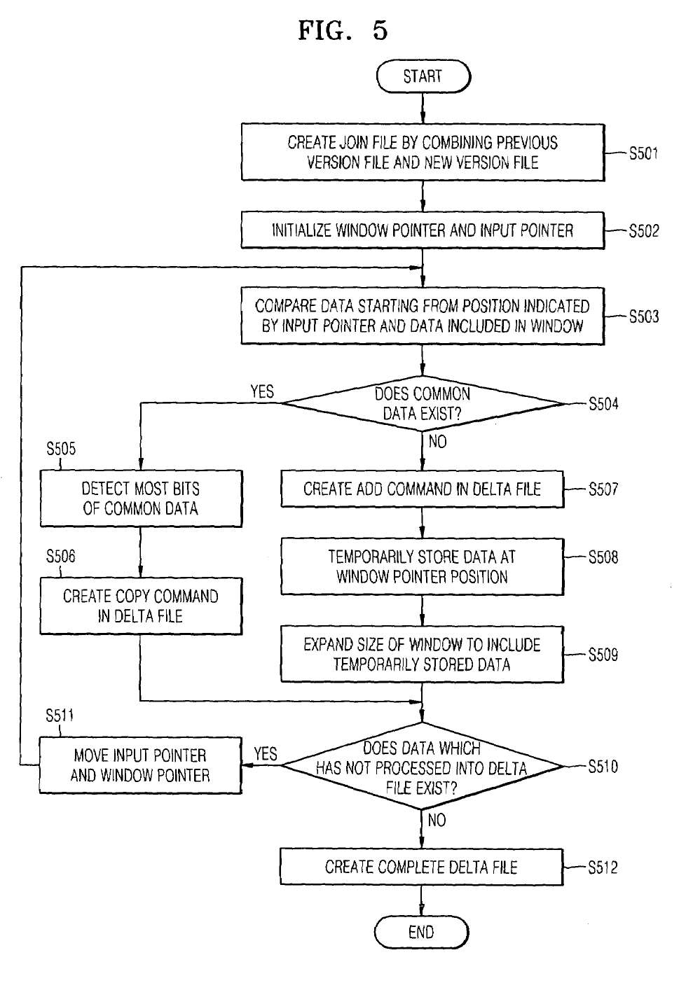

A method of creating the delta file in the delta file creating module 320 will be described with reference to a flow chart illustrated in FIG. 5.

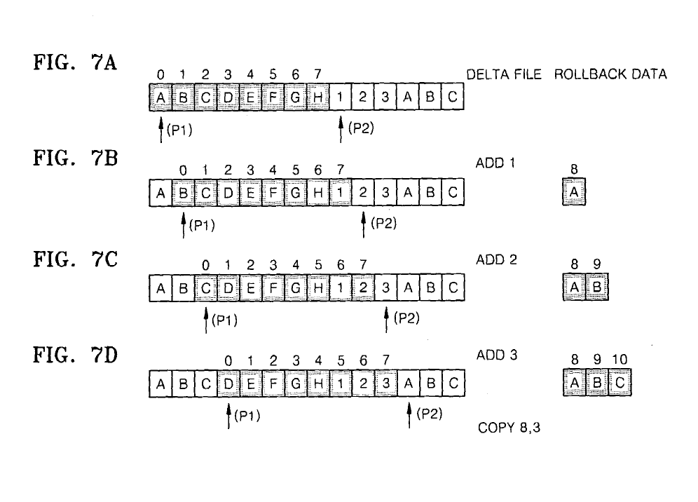

First, a join file is created by combining the previous version file 310 and the new version file 320 (S501). For example, if the previous version file 310 is [A B C D E F G H] and the new version file 320 is [1 2 3 A B C], the join file will be [A B C D E F G H 1 2 3 A B C] as shown in FIG. 7A.

Next, locations of a window pointer P1 and an input pointer P2 are initialized (S502). The window pointer P1 that indicates a window start position is initialized to indicate a beginning point of the join file. The input pointer P2 that indicates a comparison starting point of the join file is initialized to indicate a beginning point of the new version file included in the join file.

The locations of the window pointer P1 and the input pointer P2 after initialization are as shown in FIG. 7A.

Next, data starting from the input pointer P2 position is compared with data included in the window (that is, data included between window addresses 0-7) (S503).

After comparing the data in operation S503, it is determined whether there is common data (S504).

If there is no common data, an ADD command is created in the delta file (S507).

Specifically, referring to FIG. 7A, since data starting from the position indicated by the input pointer P2, that is, “1”, is not included in the window (0-7 of the window address) which is hatched, code related to the ADD I command is written to the delta file.

Next, data of a previous version that will be replaced and deleted according to the ADD command is temporarily stored as rollback data (S508). That is, the data which will be replaced and deleted according to the ADD command corresponds to data indicated by the window pointer P1, and the rollback data is “A” as in FIG. 7A.

The window size is expanded to include the temporarily stored rollback data (S509). Specifically, the window size corresponds to a data range between window addresses 0-7, but after the rollback data is created, the window size is expanded to correspond to a data range between window addresses 0-8, as shown in FIG. 7B.

Next, it is determined whether there is data which has not been processed into the delta file among data of the new version file included in the join file (S510).

If there is data that has not been processed into the delta file, each of the input pointer P2 and the window pointer P1 is moved to process the next data (S511). When the ADD command is created in the delta file, the input pointer P2 and the window pointer P1 individually advance to the next data, and when the COPY command is created, the input pointer P2 and the window pointer P1 move forward according to the length of the COPY command.

Specifically, when the ADD 1 command is created in the delta file as shown in FIG. 7A, the input pointer P2 and the window pointer P1 move forward to the next data as shown in FIG. 7B.

After performing operation S511, the procedure goes back to the operation S503 and then the procedure is repeated.

Through these operations, the window is expanded to include the rollback data “A” in FIG. 7B. Then, as shown in FIG. 7B, code related to an ADD 2 command is written to portions of the delta file indicated by the window pointer P1 and the input pointer P2, and “B” is added to the rollback data.

To this end, the window is expanded to include the rollback data “A B” in FIG. 7C. Then, as shown in FIG. 7C, code related to an ADD 3 command is written to portions of the delta file indicated by the window pointer P1 and the input pointer P2, and “C” is added to the rollback data.

As the result of adding “C” to the rollback data, the window is expanded to include the rollback data “A B C” in FIG. 7D.

A procedure of creating a delta file at the positions of the window pointer P1 and the input pointer P2 in FIG. 7D will be described below.

In a state where the window pointer P1 and the input pointer P2 are located after the delta file is created, the operation S503 is performed to create a delta file related to the next data.

Specifically, according to operation S503, data starting from the point indicated by the input pointer P2 is compared with data included in the window. The window is expanded to include the rollback data “A B C” which temporarily store the data of the original file (the previous version file) that has been replaced and will be deleted according to the ADD command as described above.

Consequently, in the operation S504, it is determined that the window within the join file doesn't include the data “A” which starts from the point indicated by the input pointer P2 but the rollback data included in a window region contains common data.

Therefore, since it is determined that common data is present, the total amount of common data of the data starting from the position indicated by the input pointer P2 and the data included in the window is detected (S505). In FIG. 7D, the total continuous common data is “A B C”.

Next, the COPY command is created in the delta file to copy the total continuous common data detected in operation S505 (S506). That is, code related to a command COPY 8, 3 as shown in FIG. 7D, is written to the delta file. In the command COPY 8, 3, “8” denotes the position where data is copied from and “3” indicates the length of the data to be copied.

In FIG. 7D, because data of the new version file that has not been processed into the delta file is not present in the join file after the delta file is created, a delta file 340 (referring to FIG. 3) is finally completely created (S512). That is, the final complete delta file is composed of commands ADD 1 2 3 and COPY 8, 3.

Referring to FIG. 3 again, according to the procedures described above, the delta file 340 created in the delta file creating module 320 of the first computer 10 is stored in a storage unit 350.

Then, the first computer 10 transmits the delta file 340 to the second computer 20 where a software patch is to be implemented through a communication module 360. 1641 The second computer 20 receives the delta file 340 transmitted from the first computer 10 through the communication module 360, and then the previous version file is overwritten using the delta file 340 in a patch module 380 so that the new version file 330 can be created. Therefore, during the patch operation, the previous version file 310 and the new version file 330 do not exist separately, but the previous version file 310 is changed into the new version file 330.

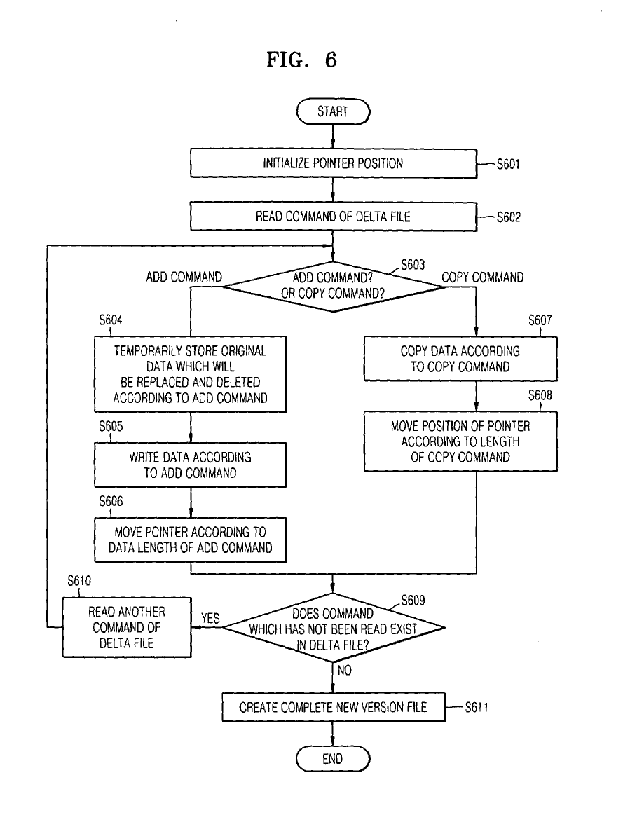

A method of creating the new version file 330 by overwriting the previous version file 310 using the delta file 340 in the patch module 380 will be described below in detail with reference to a flow chart of FIG. 6.

First, a position of a pointer P3 is initialized (S601). That is, the position of the pointer P3 is initialized to indicate a beginning point of the previous version file (original file) 310.

Then, commands in the transmitted delta file 340 are read (S602). For reference, the delta file 340 is composed of commands ADD 1 2 3 and COPY 8, 3 in the present exemplary embodiment.

After reading the commands; it is determined if the command is an ADD command or a COPY command (S603).

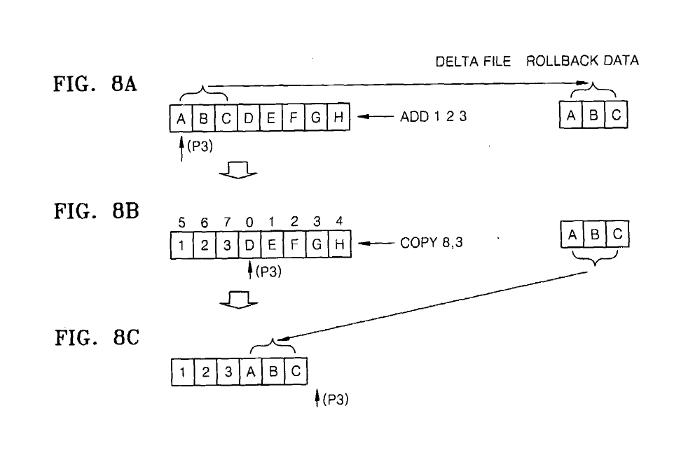

When it is determined that the command is the ADD command, a part of data of the previous version file 310 is temporarily stored as rollback data, from the current position of the pointer P3 to a position determined according to the length of the ADD command (S604). Referring to FIG. 8A, since the first command of the delta file is the ADD 1 2 3 command, data “A B C” which will be replaced and deleted according to the ADD command is temporarily stored as the rollback data.

Data of the ADD command is overwritten on the previous version file 310 (S605). For example, when the command ADD 1 2 3 is implemented, three pieces of data “1”, “2”, and “3” are sequentially written on the previous file 310 from the position of the pointer P3 as shown in FIG. 8B.

Subsequently, the pointer P3 is moved from the current position by a distance equal to the length of the data written according to the ADD command (S606). Therefore, after the command ADD 1 2 3 is implemented, the position of the pointer P3 is moved as shown in FIG. 8B.

After the pointer P3 is moved, it is determined if an unread command is present in the delta file 340 (S609).

If it is determined that there is an unread command that exists in the delta file 340, the command is read from the delta file 340 (S610). That is, after overwriting is performed according to the command of ADD 1 2 3 included in the delta file 340, the other command, that is, the COPY 8, 3 command, is read from the delta file 340.

Then, because the command read from the delta file is the COPY command, the procedure proceeds to operation S607 in which data copy is performed according to the COPY command (S607). That is, in operation S607, the command of COPY 8, 3 is performed. Referring to FIG. 8B, “8” of the copy command denotes the position where the copy is performed. This corresponds to the position where the rollback data is stored. The rollback data “A B C” is copied to a position of the previous version file 310 which is indicated by the pointer P3. As the result, the previous version file 310 is changed as shown in FIG. 8C.

After the copy command is implemented, the pointer P3 is moved according to the length of the COPY command (S608).

After operation S606 or S608 is performed, it is determined if an unread command remains in the delta file 340 (S609).

If it is determined that an unread command remains, the command is read (S610) and then the procedure goes back to operation S603 and the above operations are repeated.

Alternatively, if it is determined that all commands in the delta file 340 have been read, the new version file 330 is finally completely created as shown in FIG. 8C (S611).

Referring to FIG. 3 again, the new version file 330 created in the patch module 380 of the second computer 20 according to the above procedures is stored in the storage unit 390.

According to the exemplary embodiment of the present invention, data of an original file which would be deleted according to an ADD command if an in-place patch method is used to create a delta file is separately stored temporarily, and this data of the original file which has been temporarily stored that will be deleted is reused for delta file creation and patch operation. Therefore, the size of the delta file can be reduced.

The embodiments of the present invention can be written as computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet).

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of creating a delta file, the method comprising:
creating a delta file, which comprises a COPY command and an ADD command that are based on a difference between a previous version file and a new version file, by moving a window according to a sliding window method and expanding a size of the window to include data of the previous version file which will be replaced and deleted according to the ADD command while creating the delta file.

2. The method of claim 1, wherein the creating of the delta file comprises:
creating a join file with a series of data by combining the data of the previous version file and data of the new version file;
comparing data included in the window and the data of the new version file starting from a position indicated by an input pointer while moving a window pointer which indicates a window starting point and the input pointer in unison by applying the sliding window method to the join file;
if it is determined that there is common data based on the comparing of the data included in the window and the data of the new version file, creating the COPY command in the delta file; and
if it is determined that there is no common data based on the comparing of the data included in the window and the data of the new version file, creating the ADD command in the delta file.

3. The method of claim 2, wherein the window pointer is moved starting from a beginning portion of the join data and the input pointer is moved starting from a beginning portion of the data of the new version file which is included in the join data to the end portion of the data in unison with the window pointer.

4. The method of claim 2, wherein in the comparing of the data, the data starting from the position indicated by the input pointer and the data within the window are compared and total continuous common data is determined.

5. The method of claim 1, wherein the expanding the size of the window comprises:
temporarily storing the data of the previous version file that will be replaced and deleted according to the ADD command while creating the delta file; and
expanding the size of the window to include the temporarily stored data.

6. A computer readable recording medium with a computer program for executing a method of creating a delta file, the method comprising:
creating a delta file, which comprises a COPY command and an ADD command that are based on a difference between a previous version file and a new version file, by moving a window according to a sliding window method and expanding a size of the window to include data of the previous version file which will be replaced and deleted according to the ADD command while creating the delta file.

7. A method of performing a software patch by a method of directly overwriting an original file according to commands in a delta file, the method comprising:
if a command of the delta file is an ADD command, temporarily storing data of the original file that will be deleted according to the ADD command and writing the data to the original file according to the ADD command; and
performing a COPY command of the delta file using the temporarily stored data.

8. A method of performing a software patch by a method of directly overwriting an original file using a delta file, the method comprising:
a) positioning a pointer at a beginning portion of the original file;
b) determining whether a command of the delta file is an ADD command or a COPY command;
c) if it is determined that the command of the delta file is the ADD command, temporarily storing data at a position indicated by the pointer, writing data according to the ADD command at the position indicated by the pointer, and moving the pointer according to a data length of the ADD command; and
d) if it is determined that the command of the delta file is the COPY command, copying data corresponding to an address and length of the COPY command at the position indicated by the pointer, and moving the pointer according to a data length of the COPY command.

9. The method of claim 8, wherein after the pointer is moved according to the data length of the ADD command or a data length of the COPY command, another command is read and then the operations are repeated starting from operation b).

10. The method of claim 8, wherein in operation c), the temporarily stored data is used for the COPY command.

11. A computer readable recording medium storing a computer program for executing a method of performing a software patch by a method of directly overwriting an original file using a delta file, the method comprising:
a) positioning a pointer at a beginning portion of the original file;
b) determining whether a command of the delta file is an ADD command or a COPY command;
c) if it is determined that the command of the delta file is the ADD command, temporarily storing data at a position indicated by the pointer, writing data according to the ADD command at the position indicated by the pointer, and moving the pointer according to a data length of the ADD command; and
d) if it is determined that the command of the delta file is the COPY command, copying data corresponding to an address and length of the COPY command at the position indicated by the pointer, and moving the pointer according to a data length of the COPY command.

12. A method of updating software, the method comprising:
a) creating a delta file using a sliding window method while expanding a size of a window to include data of a previous version file which will be replaced and deleted according to an ADD command;
b) receiving the created delta file; and
c) reading the received delta file, and if a command of the delta file is the ADD command, temporarily storing data of a previous version file which will be replaced and deleted according to the ADD command, writing data of the ADD command to an original file, and performing a software patch using the temporarily stored data.

13. The method of claim 12, wherein the operation a) comprises:
a1) creating a join file with a series of data by combining data of the previous version file and data of a new version file;
a2) comparing data included in the window and the data of the new version file that starts from a position indicated by an input pointer while moving a window pointer and the input pointer in unison by applying a sliding window method to the join file;
a3) if it is determined that there is common data after comparing the data included in the window and the data of the new version file, creating a COPY command in the delta file, or if it is determined that there is no common data, creating the ADD command in the delta file;
a4) temporarily storing the data of the previous version file which will be replaced and deleted according to the ADD command; and
a5) expanding the size of the window to include the temporarily stored data.

14. The method of claim 12, wherein operation c) comprises:
c1) positioning a pointer at a beginning point of the previous version file
c2) determining whether the command of the delta file is the ADD command or COPY command;
c3) if it is determined that the command of the delta file is the ADD command, temporarily storing data at the position indicated by the pointer, writing data according to the ADD command at the position indicated by the pointer, and moving the pointer according to a data length of the ADD command; and
c4) if it is determined that the command of the delta file is the COPY command, copying data corresponding to an address and a data length of the COPY command at the position indicated by the pointer, and moving the pointer according to the data length of the COPY command.

15. The method of claim 14, wherein after the pointer is moved according to the data length of the ADD command or the data length of the COPY command, another command is read and then the operations are repeated starting from operation c2).

16. The method of claim 14, wherein in operation c3), the temporarily stored data is used for the COPY command.

17. A computer readable recording medium storing a computer program for executing a method of updating software, the method comprising:
a) creating a delta file using a sliding window method while expanding a size of a window to include data of a previous version file which will be replaced and deleted according to an ADD command;
b) receiving the created delta file; and
c) reading the received delta file, and if a command of the delta file is the ADD command, temporarily storing data of a previous version file which will be replaced and deleted according to the ADD command, writing data of the ADD command to an original file, and performing a software patch using the temporarily stored data.

18. A server computer comprising:
a delta file creating module that creates a delta file based on a difference between a previous version file and a new version file according to an ADD command and a COPY command using a sliding window method and expands a size of a window to include data of the previous version file which will be replaced and deleted according to the ADD command while creating the delta file; and
a storage unit that stores the delta file created by the delta file creating module.

19. The server computer of claim 18, wherein a window pointer indicates a starting point of the window, and an input pointer indicates a comparison starting point of the new version file, and
wherein the delta file creating module combines data of the previous version file and data of the new version file to create a join file with a series of data, compares data included in the window and data of the new version file which starts from a position indicated by the input pointer while moving the window pointer and the input pointer in unison, creates the COPY command in the delta file if it is determined that there is common data based on the comparing the data included in the window and the data of the new version file, and creates the ADD command in the delta file if it is determined that there is no common data based on the comparing of the data included in the window and the data of the new version file, temporarily stores data of the previous version file which will be replaced and deleted according to the ADD command while creating the delta file, and expands the size of the window to include the temporarily stored data.

20. A client computer comprising:
a patch module that overwrites a previous version file according to a command included in a delta file, and if the command is an ADD command, temporarily stores data of the previous version file that will be replaced and deleted according to the ADD command, writes data according to the ADD command to the previous version file, and performs a software patch using the temporarily stored data; and
a storage unit that stores the delta file created by the patch module.

21. The client computer of claim 20, wherein a pointer indicates an overwriting starting position of the previous version file, and
wherein the patch module determines whether the command of the delta file is the ADD command or a COPY command, temporarily stores data located at the position indicated by the pointer if the command of the delta file is the ADD command, writes data according to the ADD command at the position indicated by the pointer and moves the pointer according to a data length of the ADD command if the command of the delta file is the ADD command, and copies data corresponding to an address and a data length of the COPY command at a position indicated by the pointer and moves the pointer according to the data length of the COPY command if the command of the delta file is the COPY command.
